(19) United States
(12) Patent Application Publication
(10) Pub. No.: US 2026/0001259 A1
(43) Pub. Date: Jan. 1, 2026

(54) TECHNOLOGY FOR PREPARING HIGH-TEMPERATURE-RESISTANT EPOXY ENERGY STORAGE FILM BASED ON LIQUID CRYSTALLINE ORDERED STRUCTURE

(71) Applicant: Xi’an University of Architecture and Technology, Xi'an (CN)

(72) Inventors: Zhengdong Wang, Xi'an (CN); Botao Liu, Xi'an (CN); Mengli Li, Xi'an (CN); Xiaolong Cao, Xi'an (CN); Bin Cheng, Xi'an (CN)

(73) Assignee: Xi’an University of Architecture and Technology, Xi'an, SN (CN)

(21) Appl. No.: 19/319,307

(22) Filed: Sep. 4, 2025

(30) Foreign Application Priority Data
Jan. 14, 2025 (CN) 202510056609.9

(51) Int. Cl. B29C 43/52; B29C 33/68; B29C 43/00; B29C 43/22; B29K 63/00; B29K 105/00; B29K 105/24; B29L 7/00

(52) U.S. Cl. CPC B29C 43/52; B29C 33/68; B29C 43/003; B29C 43/22; B29K 2063/00; B29K 2105/0002; B29K 2105/0067; B29K 2105/0079; B29K 2105/24; B29L 2007/008

(57) ABSTRACT

A technology for preparing a high-temperature-resistant epoxy energy storage film based on a liquid crystalline ordered structure includes: S1, mixing a biphenyl type liquid crystalline epoxy (LCE) monomer, a bisphenol-A epoxy monomer, and a curing agent at a certain ratio, while performing magnetic stirring treatment and oil-bath heating melting treatment, to obtain a molten mixture; and S2, performing degassing treatment on the molten mixture obtained in the S1, and then pouring the degassed mixture into a mold; and performing heating curing treatment on the degassed mixture through a hot-press approach to obtain an epoxy film. Incorporation of highly polarized C—F bonds into the liquid crystalline molecule-modified epoxy film increases an energy storage density of the epoxy film, and enhances high-temperature energy storage characteristics of the epoxy film; moreover, the cured epoxy film has a liquid crystalline ordered structure and achieves a synchronous enhancement of a thermal conductivity.

### TECHNICAL FIELD

The present disclosure relates to the technical field of dielectric energy storage, and in particular to a technology for preparing a high-temperature-resistant epoxy-based energy storage film based on a liquid crystalline ordered structure.

### BACKGROUND

Power devices such as high-voltage insulated gate bipolar transistors (IGBT) are widely applied in ultra-high voltage (UHV) polymer dielectrics, which exhibit properties such as a high dielectric constant, a low dielectric loss, a high power density, a high charge-discharge efficiency, a large operating voltage/current, a high reliability, and a low cost, and thus are extensively used as energy storage materials of capacitors for high-power rapid regulation of smart grids and AC-DC conversion of electric vehicles. As distributed renewable power generation is integrated into a power system, a distributed grid undergoes elevated load and complicated supply-demand regulation. Therefore, capacitors with a high energy storage density and a low dielectric loss are required to achieve high-power rapid regulation of smart grids.

Biaxially oriented polypropylene (BOPP) is widely used as a commercial energy storage dielectric due to an extremely low dielectric loss (tan δ≈4.0×10⁻⁴), a high dielectric strength, and excellent tensile properties. However, due to a low dielectric constant (εᵣ=2.2 at 1 kHz), the BOPP has an energy storage density (E_{w}) of only 0.5 J/cm³ at an operating electric field strength of 200 kV/mm, and in practical applications, it is usually necessary to consume more materials to meet capacity requirements. Moreover, the volume of capacitors increases due to consumption of more materials, thereby making it increasingly difficult to meet the growing capacity requirements of power inverters in limited space.

In the prior art, the dielectric constant and the dielectric strength of a dielectric material are inversely correlated. Elevating the dielectric constant of a dielectric material results in an increase in dielectric loss and leakage current, which consequently compromises the dielectric strength. How to synergistically enhance both the dielectric constant and the dielectric strength of the dielectric material, or elevate the dielectric constant without compromising the dielectric strength, has become a major focus in the research on polymer-based energy storage dielectric materials. Moreover, in AC-DC conversion applications, the operating temperatures of electronic devices are continuously rising due to development trends toward higher integration and miniaturization of power units and difficulty in heat dissipation, which imposes increasingly stringent requirements on the heat resistance of capacitors. For example, the operating ambient temperatures of power inverters in electric vehicles have reached 110-120° C. Currently, commercial BOPP films exhibit a relatively low operating temperature. When the ambient temperatures exceed 85° C., severe deterioration occurs to the dielectric loss and charge-discharge efficiency (η), and additional space is required for installing cooling systems, which further constrains BOPP applications in electric vehicle power inverters and smart grids. Therefore, it is urgent to develop energy storage dielectric materials exhibiting both a high operating temperature and a high energy storage density.

### SUMMARY

An objective of the present disclosure is to provide a technology for preparing a high-temperature-resistant epoxy energy storage film based on a liquid crystalline ordered structure, to enhance the high-temperature energy storage characteristics of epoxy films, which solves the problem of sharp degradation in energy storage performance of commercial dielectric films, and provides a new idea of developing high-performance epoxy materials for the field of dielectric energy storage.

To achieve the above objective, the present disclosure provides a technology for preparing a high-temperature-resistant epoxy energy storage film based on a liquid crystalline ordered structure, including the following steps:
S1, mixing a biphenyl type liquid crystalline epoxy (LCE) monomer (TMBP), a bisphenol-A epoxy monomer (EP-828), and a curing agent at a certain ratio, while performing magnetic stirring treatment and oil-bath heating melting treatment, to obtain a molten mixture; and
S2. performing degassing treatment on the molten mixture obtained in the S1, and then pouring the degassed mixture into a mold; and performing heating curing treatment on the degassed mixture through a hot-press approach to obtain an epoxy film.

Preferably, in the S1, the curing agent includes 2,3,4-trifluoroaniline (TFAn) and 4,4′-diaminodiphenylmethane (DDM).

Preferably, in the S1, the biphenyl type LCE monomer is optionally 4,4′-Bis(2,3-epoxypropoxy)-3,3′,5,5′-tetramethylbiphenyl (TMBP). The liquid crystalline ordered structure of the TMBP contributes to enhancing a breakdown field strength (E_{b}), a thermal conductivity, and a heat resistance.

Preferably, in the S1, a molar ratio of a sum of the bisphenol-A epoxy monomer and the biphenyl type LCE monomer to the curing agent is 3:2.

Preferably, in the S1, the magnetic stirring treatment and oil-bath heating melting treatment are specifically as follows:

A magnetic stir bar is added, and the mixture is then placed in an oil bath, and heated to a molten state, while stirred by a magnetic stirrer.

Preferably, a temperature of the oil-bath heating is 105° C., a speed of the stirring is 150-250 r/min, and a duration of the stirring is 10 min.

Preferably, in the S2, the degassing treatment is specifically as follows:

The molten mixture is placed in a vacuum drying oven and degassed in a heating reflux manner until no bubbles appear.

Bubble formation may occur during the mixing of the molten mixture, the formed bubbles may lead to inhomogeneous component distribution in the resulting molten mixture, and a large number of bubbles may reduce the breakdown strength. To avoid this condition, the degassing treatment is performed on the molten mixture prior to curing to eliminate bubbles from the molten mixture, thereby reducing the probability of insulation failure.

Preferably, a temperature of the degassing treatment is 105-110° C., and a duration of the degassing treatment is 3-5 min.

Preferably, in the S2, the heating curing treatment through a hot-press approach is specifically as follows:

First, the mold is preheated, a PET release film is then placed on a bottom of the mold, and the degassed molten mixture is poured into the copper foil mold having a thickness of 10 μm; next, an additional PET release film is overlaid on a top of the mold, the mold is sandwiched between mirror-finished stainless steel plates, and the assembly is put into a hot press for stepwise-temperature-increasing heating curing treatment.

The molten mixture is prone to low-temperature crystallization when coming into contact with low-temperature surfaces, which may cause incomplete curing reaction. To avoid this condition, in the present disclosure, the mold is first preheated to a curing temperature, and the degassed molten mixture is then poured into the preheated mold, followed by the curing treatment; a casting method is employed for pouring, and a temperature of the molten mixture during casting is that of the degassed molten mixture, i.e., 105° C.

Preferably, a temperature of the preheating treatment is 100-110° C., a temperature of the heating curing treatment is 105-200° C., and a curing duration is 10 h.

During the curing treatment, it is considered that a curing process of the biphenyl type LCE monomer consists essentially of initial chain extension, branching, and crosslinking reactions. The curing temperature significantly influences the chain extension of biphenyl liquid crystalline units, which is important for π-π stacking interactions of the biphenyl liquid crystalline units. Therefore, to ensure sufficient time for the biphenyl type LCE monomer to achieve effective chain extension, form liquid crystalline domains, attain a more complete curing degree, and obtain a higher crosslinking density, a stepwise-temperature-increasing curing process is preferred in the present disclosure. The preferred curing process includes the following steps: the biphenyl type LCE monomer is first cured in a hot press at a curing temperature of 110° C. for 4 h, then cured at a curing temperature of 160° C. for 4 h, and finally cured at a curing temperature of 200° C. for 2 h. The temperature is increased stepwise at three stages. The treatment temperature of the first stage is lower than the curing temperatures of the biphenyl type LCE monomer and the curing agent. During this stage, the biphenyl liquid crystalline units undergo π-π stacking effects, thereby facilitating self-assembly orientation to form liquid crystalline domains and further form a film of 20 μm thickness at a pressure of 200 kPa. The subsequent curing stages at 160° C. for 4 h and 200° C. for 2 h ensure complete branching and crosslinking.

Therefore, using the above technology for preparing a high-temperature-resistant epoxy energy storage film based on a liquid crystalline ordered structure, the present disclosure has the following beneficial effects:

A novel high-temperature-resistant epoxy energy storage film based on a liquid crystalline ordered structure is prepared from a biphenyl type LCE monomer (TMBP) and a bisphenol-A epoxy monomer (EP-828) as matrixes, by intrinsically regulating the structure of curing agents (TFAn and DDM) and the curing temperature, and incorporating highly polar C—F bonds into a liquid crystalline molecule-modified epoxy film. The electrical and thermal properties of the high-temperature-resistant epoxy energy storage film are characterized, which demonstrates that this method is capable of preparing energy storage dielectric materials with a high operating temperatures and a high energy storage density.

In the present disclosure, the biphenyl type LCE monomer is incorporated as a rigid group, which not only enhances the thermal resistance of polymer dielectrics, but also reduces the dielectric loss and improves the charge-discharge efficiency. Compared to conventional filled epoxy resins, the biphenyl structure in the molecular structure of the biphenyl type LCE monomer exhibits a greater rigidity, thereby further increasing resistance to internal rotation of bonds and molecular chains. Consequently, incorporation of the biphenyl liquid crystalline structure effectively enhances the thermal resistance of the epoxy film. Further, liquid crystalline molecules have excellent electrical insulation properties, and incorporation of liquid crystalline molecules into the epoxy film significantly improves the thermal resistance, thermal conductivity, and mechanical properties of the film.

Incorporation of liquid crystalline molecules into a crosslinked network (TMBP/DDM) of the epoxy film can effectively enhance the rigidity of molecular chain segments. However, the increased rigidity of the crosslinked structure of molecular chain segments restricts polarization generation, which results in a relatively low dielectric constant and an insufficient energy storage density of the epoxy film. To address the deficiency in dielectric constant, incorporating highly polarized C—F bonds into the crosslinked system of the liquid crystalline molecule-modified epoxy resin (TMBP/EP11) effectively enhances the dielectric constant and energy storage density of the epoxy film. Additionally, incorporating amine-terminated TFAn enables regulation of the crosslinking density of the epoxy film, thereby achieving control over film-forming capability and mechanical properties.

The technical solutions of the present disclosure will be further described below in detail through the drawings and examples.

### BRIEF DESCRIPTION OF THE DRAWINGS

FIG. 1 illustrates infrared spectra of epoxy films prepared in Examples 1-5 of the present disclosure.

FIG. 2 illustrates scanning electron microscopy (SEM) images of cross-sectional structures and planar structures of epoxy films prepared in Examples 1, 3, and 5 of the present disclosure, where (a) depicts cross-sectional morphology observed by SEM for Example 1; (b) depicts cross-sectional morphology observed by SEM for Example 3; (c) depicts cross-sectional morphology observed by SEM for Example 5; (d) depicts surface morphology observed by SEM for Example 1; (e) depicts surface morphology observed by SEM for Example 3; and (f) depicts surface morphology observed by SEM for Example 5.

FIG. 3 illustrates differential scanning calorimetry (DSC) test results of epoxy films prepared in Examples 1 to 5 of the present disclosure.

FIG. 4 illustrates tensile property test results of epoxy films prepared in Examples 1 to 5 of the present disclosure.

FIG. 5 illustrates through-plane thermal conductivity test results of epoxy films prepared in Examples 1 to 5 of the present disclosure.

FIG. 6 illustrates in-plane thermal conductivity test results of epoxy films prepared in Examples 1 to 5 of the present disclosure.

FIG. 7 illustrates dielectric property test results of epoxy films prepared in Examples 1 to 5 of the present disclosure.

FIG. 8 illustrates electric dipole moment results of molecules obtained through quantum chemical calculations for Examples 1, 3, and 5 of the present disclosure, where (a) corresponds to Example 1; (b) corresponds to Example 3; and (c) corresponds to Example 5.

FIG. 9 illustrates dielectric spectrum test results of epoxy films prepared in Examples 1 to 5 at different temperatures, where (a) corresponds to Example 1; (b) corresponds to Example 3; (c) corresponds to Example 5; and (d) depicts a comparison of dielectric losses of the three films at 10 Hz and different temperatures.

FIG. 10 illustrates a comparison of direct current (DC) dielectric strengths of epoxy films prepared in Examples 1 to 5 of the present disclosure.

FIG. 11 illustrates calculated results of electrostatic potential distribution on electron charge density isosurfaces based on a density functional theory for Examples 1, 3, and 5 of the present disclosure, where (a) corresponds to Example 1; (b) corresponds to Example 3; and (c) corresponds to Example 5.

FIG. 12 schematically illustrates crosslinked structures of molecular chains for Examples 1, 3, and 5 of the present disclosure, where (d) corresponds to Example 1; (e) corresponds to Example 3; and (f) corresponds to Example 5.

FIG. 13 illustrates calculated results of free volume fractions of three crosslinked systems based on a Forcite module for Examples 1, 3, and 5 of the present disclosure, where (g) corresponds to Example 1; (h) corresponds to Example 3; and (i) corresponds to Example 5.

FIG. 14 illustrates DC breakdown test results of epoxy films prepared in Examples 1, 3, and 5 of the present disclosure at different temperatures, where (a) corresponds to Example 1; (b) corresponds to Example 3; and (c) corresponds to Example 5.

FIG. 15 illustrates partial discharge test results of epoxy films prepared in Examples 1, 3, and 5 of the present disclosure, where (a) corresponds to Example 1; (b) corresponds to Example 3; (c) corresponds to Example 5; and (d) depicts average partial discharge magnitudes.

FIG. 16 illustrates thermally stimulated current (TSC) analysis results of epoxy films prepared in Examples 1, 3, and 5 of the present disclosure, where (a) depicts TSC curves; (b) depicts peak fitting curves of a TMBP/EP11 system; and (c) depicts peak fitting curves of a 3F@TMBP/EP11 system.

FIG. 17 illustrates high-temperature electrical conductivity test results of epoxy films prepared in Examples 1 and 3 of the present disclosure.

FIG. 18 illustrates electric hysteresis loop results of epoxy films prepared in Examples 1 to 5 of the present disclosure at different electric field strengths and test temperatures, where (a) corresponds to Example 1; (b) corresponds to Example 2; (c) corresponds to Example 3; (d) corresponds to Example 4; (e) corresponds to Example 5; (f) illustrates results under identical electric field strength conditions; (g) illustrates results of Example 1 at different test temperatures; (h) illustrates results of Example 3 at different test temperatures; and (i) illustrates results of Example 5 at different test temperatures.

FIG. 19 illustrates energy storage performance comparison results of epoxy films prepared in Examples 1 to 5 of the present disclosure, where (a) illustrates results at room temperature; (b) illustrates results under different temperature conditions; (c) illustrates a comparison in energy storage density between this study and other studies or commercial films at room temperature with a charge-discharge efficiency exceeding 90%; and (d) illustrates a comparison in charge-discharge efficiency between this study and other studies or commercial films at 140° C. and 200 kV/mm.

FIG. 20 illustrates high-temperature energy storage cycling performance test results of an epoxy film prepared in Example 3 of the present disclosure at 200 kV/mm and different temperatures.

FIG. 21 schematically illustrates a self-healing process of a metallized film according to the present disclosure.

FIG. 22 illustrates a comparison of pre-breakdown and post-breakdown morphologies and energy storage performances of an epoxy film prepared in Example 3 of the present disclosure, where (a) is a pre-breakdown SEM image; (b) depicts pre-breakdown energy dispersive spectroscopy (EDS) analysis; (c) is a post-breakdown polarizing optical microscopy (POM) image; (d) is a post-breakdown SEM image; (e) depicts post-breakdown EDS analysis; and (f) depicts a comparison of pre-breakdown and post-breakdown energy storage performances.

### DETAILED DESCRIPTIONS OF THE EMBODIMENTS

The technical solutions of the present disclosure will be further described below through the drawings and examples.

Unless otherwise defined, technical or scientific terms used herein should have the ordinary meanings as understood by those of ordinary skill in the art to which the present disclosure belongs.

### Example 1

This example provides a high-temperature-resistant epoxy energy storage film based on a liquid crystalline ordered structure, a preparation technology of which is as follows:

0.5 g of TMBP, 0.5 g of EP, and 0.272 g of DDM were mixed, and a magnetic stir bar was added. The mixture was then placed in an oil bath at 105° C., heated to a molten state, and stirred by a magnetic stirrer for 10 min. After stirring, the magnetic stir bar was removed using a magnet. The resulting molten mixture was then placed in a vacuum drying oven at 90° C. for degassing until no bubbles appeared. A PET release film was placed on a bottom of a mold, the degassed molten mixture was poured into a copper foil mold having a thickness of 20 μm, and finally an additional PET release film was overlaid on a top of the mold. The mold was sandwiched between mirror-finished stainless steel plates, the assembly was put into a hot press, and the molten mixture was cured at a curing temperature of 110° C. for 4 h, at a curing temperature of 160° C. for 4 h, and at a curing temperature of 200° C. for 2 h sequentially. An epoxy resin with both heat resistance and energy storage properties was obtained, designated as TMBP/EP11.

### Example 2

This example provides a high-temperature-resistant epoxy energy storage film based on a liquid crystalline ordered structure, a preparation technology of which is as follows:

0.5 g of TMBP, 0.5 g of EP, 0.265 g of DDM, and 0.015 g of TFAn were mixed, and a magnetic stir bar was added. The mixture was then placed in an oil bath at 105° C., heated to a molten state, and stirred by a magnetic stirrer for 10 min. After stirring, the magnetic stir bar was removed using a magnet. The resulting molten mixture was then placed in a vacuum drying oven at 90° C. for degassing until no bubbles appeared. A PET release film was placed on a bottom of a mold, the degassed molten mixture was poured into a copper foil mold having a thickness of 20 μm, and finally an additional PET release film was overlaid on a top of the mold. The mold was sandwiched between mirror-finished stainless steel plates, the assembly was put into a hot press, and the molten mixture was cured at a curing temperature of 110° C. for 4 h, at a curing temperature of 160° C. for 4 h, and at a curing temperature of 200° C. for 2 h sequentially. An epoxy resin with both heat resistance and energy storage properties was obtained, designated as 1F@TMBP/EP11.

### Example 3

This example provides a high-temperature-resistant epoxy energy storage film based on a liquid crystalline ordered structure, a preparation technology of which is as follows:

0.5 g of TMBP, 0.5 g of EP, 0.247 g of DDM, and 0.04 g of TFAn were mixed, and a magnetic stir bar was added. The mixture was then placed in an oil bath at 105° C., heated to a molten state, and stirred by a magnetic stirrer for 10 min. After stirring, the magnetic stir bar was removed using a magnet. The resulting molten mixture was then placed in a vacuum drying oven at 90° C. for degassing until no bubbles appeared. A PET release film was placed on a bottom of a mold, the degassed molten mixture was poured into a copper foil mold having a thickness of 20 μm, and finally an additional PET release film was overlaid on a top of the mold. The mold was sandwiched between mirror-finished stainless steel plates, the assembly was put into a hot press, and the molten mixture was cured at a curing temperature of 110° C. for 4 h, at a curing temperature of 160° C. for 4 h, and at a curing temperature of 200° C. for 2 h sequentially. An epoxy resin with both heat resistance and energy storage properties was obtained, designated as 3F@TMBP/EP11.

### Example 4

This example provides a high-temperature-resistant epoxy energy storage film based on a liquid crystalline ordered structure, a preparation technology of which is as follows:

0.5 g of TMBP, 0.5 g of EP, 0.22 g of DDM, and 0.08 g of TFAn were mixed, and a magnetic stir bar was added. The mixture was then placed in an oil bath at 105° C., heated to a molten state, and stirred by a magnetic stirrer for 10 min. After stirring, the magnetic stir bar was removed using a magnet. The resulting molten mixture was then placed in a vacuum drying oven at 90° C. for degassing until no bubbles appeared. A PET release film was placed on a bottom of a mold, the degassed molten mixture was poured into a copper foil mold having a thickness of 20 μm, and finally an additional PET release film was overlaid on a top of the mold. The mold was sandwiched between mirror-finished stainless steel plates, the assembly was put into a hot press, and the molten mixture was cured at a curing temperature of 110° C. for 4 h, at a curing temperature of 160° C. for 4 h, and at a curing temperature of 200° C. for 2 h sequentially. An epoxy resin with both heat resistance and energy storage properties was obtained, designated as 6F@TMBP/EP11.

### Example 5

This example provides a high-temperature-resistant epoxy energy storage film based on a liquid crystalline ordered structure, a preparation technology of which is as follows:

0.5 g of TMBP, 0.5 g of EP, 0.183 g of DDM, and 0.13 g of TFAn were mixed, and a magnetic stir bar was added. The mixture was then placed in an oil bath at 105° C., heated to a molten state, and stirred by a magnetic stirrer for 10 min. After stirring, the magnetic stir bar was removed using a magnet. The resulting molten mixture was then placed in a vacuum drying oven at 90° C. for degassing until no bubbles appeared. A PET release film was placed on a bottom of a mold, the degassed molten mixture was poured into a copper foil mold having a thickness of 20 μm, and finally an additional PET release film was overlaid on a top of the mold. The mold was sandwiched between mirror-finished stainless steel plates, the assembly was put into a hot press, and the molten mixture was cured at a curing temperature of 110° C. for 4 h, at a curing temperature of 160° C. for 4 h, and at a curing temperature of 200° C. for 2 h sequentially. An epoxy resin having a liquid crystalline ordered structure and exhibiting high heat resistance and high thermal conductivity was obtained, designated as 10F@TMBP/EP11.

### Experimental Testing

### (1) Molecular Structural Characterization

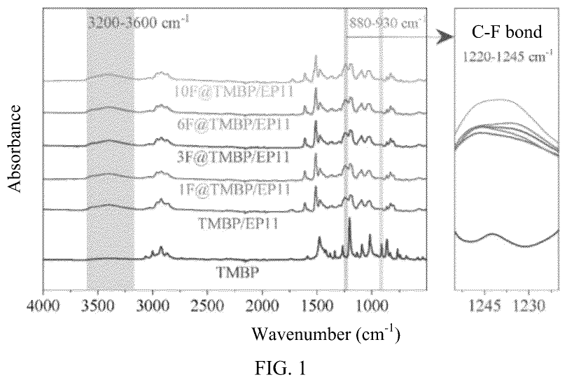

FIG. 1 illustrates normalized infrared spectra of epoxy films prepared in Examples 1 to 5 based on standard TMBP under different crosslinking curing systems. In the figure, the absorption bands at 3,200-3,600 cm⁻¹ correspond to hydroxyl stretching vibrations, the absorption bands at 2,800-3,100 cm⁻¹ correspond to alkyl group stretching vibrations, the absorption bands at 1,450-1,600 cm⁻¹ correspond to aromatic ring stretching vibrations, and the absorption bands at 1,000-1,200 cm⁻¹ correspond to C—O bond stretching vibrations. No discernible characteristic peaks corresponding to secondary amine groups (brown shaded region) at 3,200-3,400 cm⁻¹ or to epoxy groups (blue shaded region) at 913 cm⁻¹ are observed, indicating complete reaction of both epoxy resins with the curing agent. The characteristic peaks corresponding to C—F bonds are observed in the range of 1,220-1,245 cm⁻¹. Upon incorporating C—F bonds into the crosslinking systems, evident gradient variations in peak within this range are observed among the five systems, indicating successful grafting of C—F bonds in the four C—F bond-modified systems.

### (2) Morphological Characterization

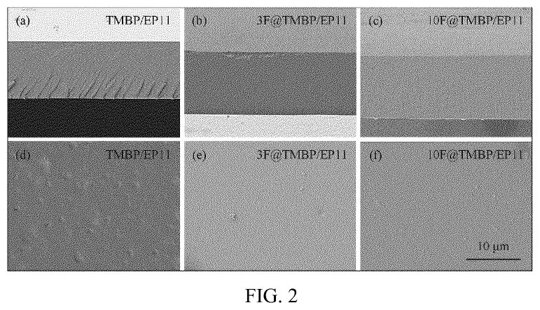

Morphological characterization of epoxy films prepared in Examples 1, 3, and 5 was performed using a field emission scanning electron microscopy (SEM, Zeiss GeminiSEM 500), with the results shown in FIG. 2. It is observable that with increasing incorporation of C—F bonds, both the fracture surfaces and cross-sections of the films become progressively smoother. The cross-section of the TMBP/EP11 crosslinking system exhibits numerous serrated textures, the cross-section of the 3F@TMBP/EP11 crosslinking system shows significantly reduced serrated textures, and the cross-section of the 10F@TMBP/EP11 crosslinking system presents virtually no discernible textures. This phenomenon is attributed to the fact that TFAn, as a curing agent, links only two epoxy molecular chains, whereas DDM links four epoxy molecular chains. Consequently, the crosslinking density of the crosslinked structure progressively decreases with increasing incorporation of C—F bonds. The reduced crosslinking density effectively diminishes constraints on molecular chain motion to enhance the flexibility of the crosslinking system, which is favorable for application in roll-to-roll processing for metallized film capacitors.

### (3) DSC Test

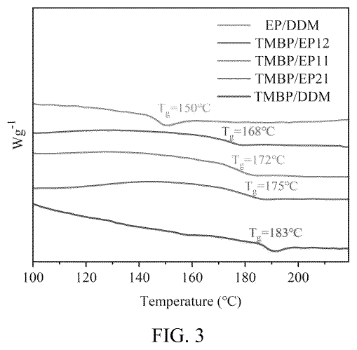

As shown in FIG. 3, glass transition temperatures (T_{g}) of the epoxy films exhibit a significant decrease with increasing incorporation of TFAn, as demonstrated by T_{g} curves of the epoxy films. The results indicate that a glass transition process of the polymeric material corresponds to the frozen-to-activated transition of chain segments within the crosslinked structure. Overlap of electron clouds in the polymer forms asymmetric delocalized π-bonds, which restricts the internal rotation of molecular chains. Consequently, polymers containing conjugated double bonds such as benzene rings exhibit high rigidity and superior thermal stability. Although TFAn contains an aromatic ring structure, incorporation of TFAn results in decreased crosslinking density of the molecular chain segments in the crosslinking system, and the decreased crosslinking density leads to diminished constraint on chain segment motion, thus causing a decrease in the glass transition temperature. However, the T_{g} of the TFAn-modified epoxy resin remains higher than that of conventional epoxy resins. The 10F@TMBP/EP11 system with the poorest heat resistance still attains a T_{g} of 135° C., fundamentally meeting the requirements for power inverters in general high-temperature operating environments. The mechanical properties of the epoxy films play a critical role in practical applications.

### (4) Tensile Property Test

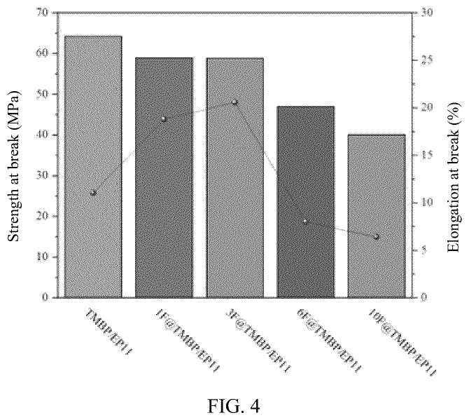

As shown in FIG. 4, tensile testing was performed on the five epoxy films. Among those epoxy films, the TMBP/EP11 system without TFAn incorporation exhibits a tensile strength at break of 64.22 MPa. Upon incorporating 1 wt %, 3 wt %, 6 wt %, and 10 wt % TFAn respectively, the tensile strengths at break decrease by 8.3%, 8.5%, 27%, and 38%. It is observed that incorporation of TFAn results in different degrees of reduction in tensile strength at break. At low incorporation levels (<3 wt %), the reduction in tensile strength at break is negligible. A sharp reduction in tensile strength at break is observed when the incorporation level exceeds 6 wt %. At low incorporation levels, the elongation at break is significantly enhanced, which effectively improves the flexibility of the polymer matrix. However, once the incorporation level exceeds a certain degree, the crosslinking density decreases markedly; and consequently, the elongation at break declines sharply due to diminished tensile strength at break.

### (5) Thermal Conductivity Test

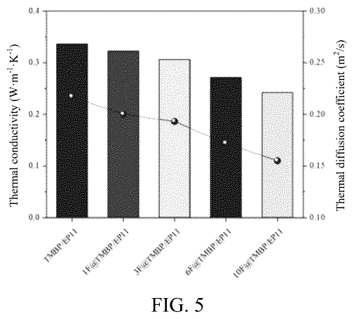

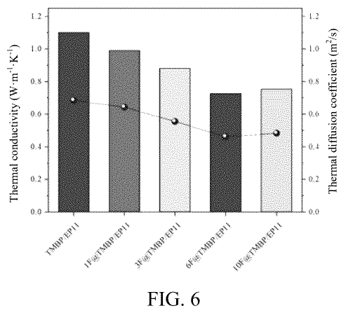

FIGS. 5 and 6 present both the through-plane and in-plane thermal conductivity test results of different crosslinking systems, respectively. Both tests reveal an identical trend: a reduction in crosslinking density in the crosslinking systems induces strong scattering of phonon transmission, thereby diminishing a mean free path of phonon transmission. This phenomenon impedes establishment of thermal conduction pathways and compromises heat diffusion. Compared to the TMBP/EP11 system, through-plane thermal conductivities of epoxy films incorporating 1 wt %, 3 wt %, 6 wt %, and 10 wt % TFAn decrease by 4.1% (0.322 W/mK), 8.9% (0.306 W/mK), 19.3% (0.271 W/mK), and 28% (0.242 W/mK), respectively, and the through-plane thermal conductivity of the TMBP/EP11 system is 0.336 W/mK; in-plane thermal conductivities of the epoxy films incorporating 1 wt %, 3 wt %, 6 wt %, and 10 wt % TFAn decrease by 10% (0.99 W/mK), 20% (0.88 W/mK), 34% (0.725 W/mK), and 32% (0.753 W/mK), respectively, and the in-plane thermal conductivity of the TMBP/EP11 system is 1.1 W/mK. It is observed that the thermal conductivity exhibits a trend corresponding to the tensile test results. When the incorporation level of TFAn is low, the reduction in thermal conductivity of the epoxy films is relatively minor. However, when the incorporation level of TFAn exceeds 6 wt %, a significant decrease in crosslinking density induces a pronounced decline in thermal conductivity.

### (6) Dielectric Property Characterization

### 1) Study on Impact Mechanism of C—F Bond Incorporation Level on Dielectric Properties of Epoxy Films

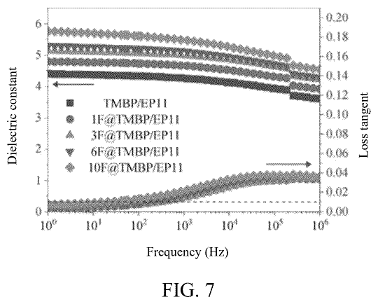

FIG. 7 illustrates dielectric properties of different epoxy films at room temperature (25° C.). Prior to incorporation of TFAn, the TMBP/EP11 system exhibits a relatively low dielectric constant of 4.36 at 10 Hz. Following incorporation of TFAn, dielectric constants at 10 Hz are 4.76 (1F@TMBP/EP11), 5.09 (3F@TMBP/EP11), 5.25 (6F@TMBP/EP11), and 5.69 (10F@TMBP/EP11), respectively. This enhancement of the dielectric constant by the highly polar C—F bonds exhibits a variation trend identical to the TFAn content in the system. This phenomenon is primarily attributed to two factors: First, incorporation of highly polar C—F bonds significantly enhances the polarization performance of molecular chain segments. Second, incorporation of C—F bonds is achieved by adding TFAn into the curing system. Unlike the curing agent DDM which links four epoxy molecular chains, TFAn contains only one secondary amine group capable of linking two epoxy chains. Consequently, the crosslinking density in the crosslinking system decreases, and constraints on chain segment motion are diminished, which facilitates oriented motion of molecular chain segments under an external electric field. To verify this theory, molecular simulation calculation was performed. Optimization calculations were performed on a minimum repeating unit of the crosslinked structure using a DMol3 module in the Materials Studio software package. Electric dipole moments of molecules were obtained through quantum chemical calculations, as shown in Table 1.

TABLE 1
Vector directions and magnitudes of dipole moments

| | | | | Dipole |
|---|---|---|---|---|
| Curing system | x | y | z | magnitude/a.u. |
| TMBP/EP11 | 0.360839 | 0.336043 | 1.839466 | 4.8406 |
| 3F@TMBP/EP11 | 2.044803 | 1.418162 | 1.351327 | 7.1975 |
| 10F@TMBP/EP11 | −2.307237 | 1.445727 | 2.528565 | 9.4447 |

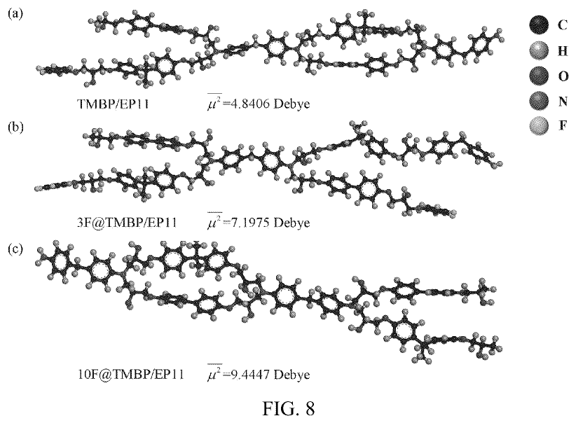

As shown in FIG. 8 and Table 1, compared with the TMBP/EP11 system, the 3F@TMBP/EP11 and 10F@TMBP/EP11 systems exhibit higher dipole moments and stronger molecular polarities. More precisely, the mean square dipole moment of the 3F@TMBP/EP11 system is calculated as 7.1945 Debye, approximately 1.48 times that of the TMBP/EP11 system (4.8406 Debye); and the mean square dipole moment of the 10F@TMBP/EP11 system reaches 9.4447 Debye, approximately 1.95 times that of the TMBP/EP11 system, as shown in Table 1. The high dipole moments observed in the 3F@TMBP/EP11 and 10F@TMBP/EP11 systems may be attributed to two aspects. First, reduced crosslinking density in the crosslinked network contributes to enhanced dipole moments due to tight connection of chemical bonds. Second, highly polar C—F bonds play a significant role in enhancing dipole moments.

### 2) Study on Impact Mechanism of Temperature on Dielectric Properties of Epoxy Films

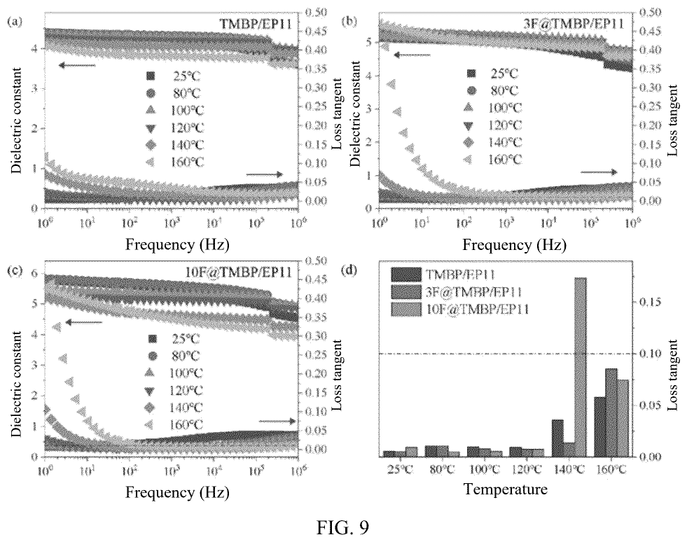

As shown in FIG. 9 and supported by DSC test results, the TMBP/EP11 system exhibits the best high-temperature stability among the five systems, with the dielectric loss still maintaining stability at 160° C. Even the system of Example 5, which exhibits the poorest high-temperature resistance among the five systems, maintains a relative stability at 140° C. The above results demonstrate that incorporation of highly polar C—F bonds effectively enhances the dielectric constants of the epoxy films with minimal impact on the high-temperature resistance, and no influence is imposed on the dielectric loss.

### (7) Dielectric Strength Characterization

### 1) Study on Impact Mechanism of C—F Bond Incorporation Level on Dielectric Strengths of Epoxy Films

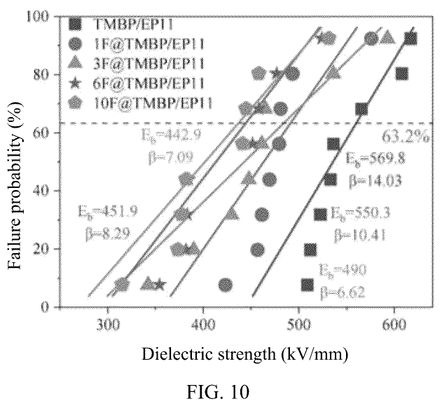

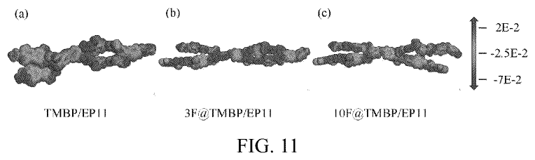

FIG. 10 illustrates the dielectric strengths of liquid crystalline molecule-modified epoxy films with different TFAn contents, where a film thickness is 10(±1) μm. The dielectric strengths of both C—F bond-modified and liquid crystalline molecule-modified epoxy films are determined by analyzing the test results using a Weibull distribution function. Prior to incorporation of TFAn, the epoxy films exhibit a dielectric strength of 569.8 kV/mm. Following incorporation of TFAn, dielectric strengths of the modified epoxy films are 500.3 kV/mm (1 wt %), 490 kV/mm (3 wt %), 451.9 kV/mm (6 wt %), and 442.9 kV/mm (10 wt %), respectively. It is found that the dielectric strengths of the crosslinking systems progressively decline with an increasing incorporation level of TFAn at room temperature. There are two primary reasons: First, as the incorporation level of TFAn increases, the content of the highly rigid curing agent DDM in the system progressively declines, and the highly rigid benzene ring structures relatively decrease, thereby weakening constraints on free electron motion. Additionally, the crosslinked structure exhibits reduced resistance to free electron bombardment. Second, the crosslinking density of the systems decreases with an increasing content of TFAn, and the rotational energy barrier of molecular chain segments lowers, thereby facilitating reorientation and displacement. Consequently, the mean free path of free electrons increases, and free electrons may acquire greater kinetic energy to impact the crosslinked structure. To verify this theory, electrostatic potential distributions on the electron charge density isosurface are calculated based on a density functional theory. As shown in FIG. 11, the red and the blue respectively represent a positive potential and a negative potential. It is observed that the TMBP/EP11 system exhibits a higher electrostatic potential than both the 3F@TMBP/EP11 system and the 10F@TMBP/EP11 system. These results indicate that the TMBP/EP11 system, with stronger repulsion or attraction effects on free electrons, effectively suppresses the mobility of free electrons and reduces the kinetic energy and impact ionization of free electrons. Due to a higher content of DDM and relatively greater abundance of phenyl structures in the TMBP/EP11 curing system, enhanced electrostatic forces are generated to repel or attract charge carriers. Enhanced electrostatic forces and restricted migration of current carriers lead to significant trap effects, which reduce the mean free path and kinetic energy of free electrons in the electric field. The calculated results indicate that the TMBP/EP11 system exhibits higher Fb due to more intensified electrostatic interactions and more pronounced trap effects. In addition to the electrostatic potential, the mobility of molecular chain segments is another important factor of determining the dielectric breakdown strength of the crosslinking system.

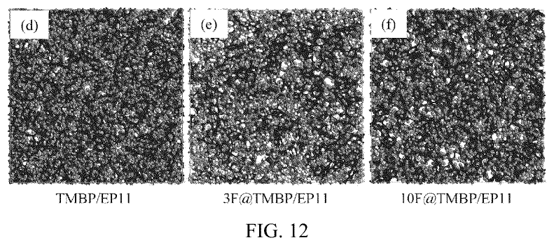

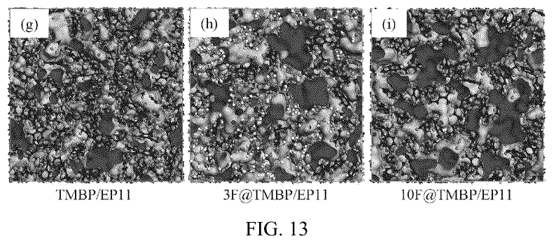

The free volume fractions of three crosslinking systems were calculated using a Forcite module. First, the crosslinked structures of molecular chains were subjected to optimization and annealing treatment to obtain structures with enhanced stability or reduced energy levels, as shown in FIG. 12. Subsequently, molecular dynamics simulation was performed on the treated crosslinked structures to determine the free volume, as shown by the blue regions in FIG. 13. The free volume refers to atomic-scale defects and voids arising from random packing of atoms. According to a dielectric breakdown theory, the free volume provides space for migration of free electrons. The calculated results indicate that the free volume fraction of the TMBP/EP11 system is greater than those of the 3F@TMBP/EP11 system and the 10F@TMBP/EP11 system. The calculated results of the free volume fractions are shown in Table 2.

TABLE 2
Free volume fractions of different crosslinking systems

| | Occupied | Free | Free volume |
|---|---|---|---|
| Curing system | volume/Å³ | volume/Å³ | fraction/% |
| TMBP/EP11 | 84034.57 | 14052.89 | 16.7 |
| 3F@TMBP/EP11 | 59092.82 | 14560.78 | 24.6 |
| 10F@TMBP/EP11 | 57708.82 | 16939.11 | 29.4 |

As indicated in Table 2 and the electrostatic potential distribution, incorporation of C—F bonds results in a decrease in the dielectric strengths of the epoxy films, which is consistent with the test results.

### 2) Study on Impact Mechanism of Temperature on Dielectric Strengths of Epoxy Films

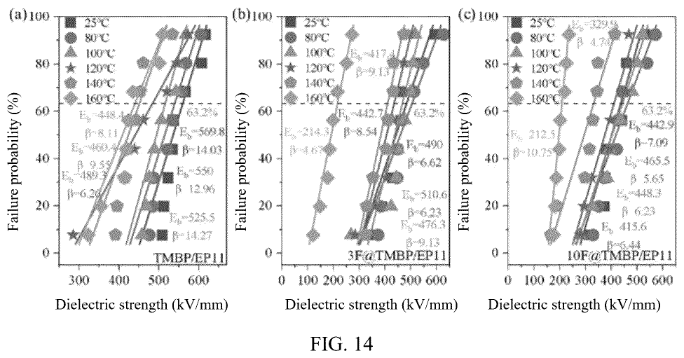

DC breakdown test was performed on three different crosslinked structures (TMBP/EP11, 3F@TMBP/EP11, and 10F@TMBP/EP11) at different temperatures, with the test results shown in FIG. 14. As the temperature gradually increases, the mobility of molecular chain segments is further enhanced. At the moment, the mean free path of free electrons is further increased, and free electrons gain greater kinetic energy. Consequently, the dielectric strengths of all crosslinking systems decrease with increasing temperature. When the temperature rises to the glass transition temperature, molecular chain segments initiate a transition from a glassy state to a rubbery state. At this point, the mobility of molecular chain segments reaches a maximum. Once the temperature continues to increase and the glassy-to-rubbery transition is fully completed, the dielectric strengths of the crosslinking systems undergo a sharp decline.

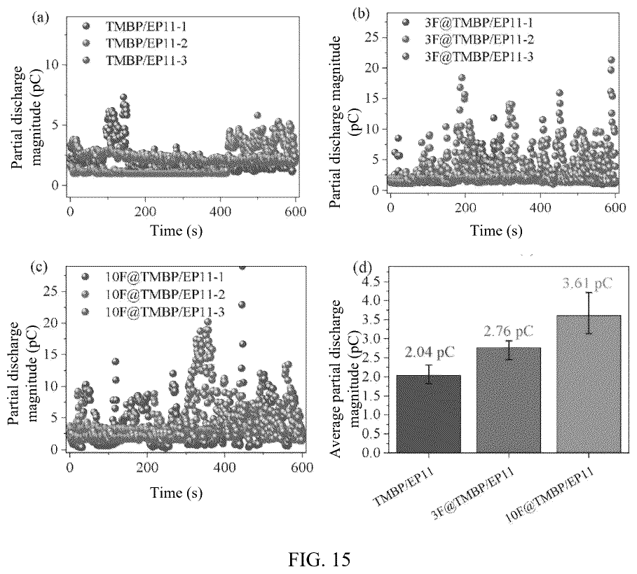

Partial discharge tests were performed to verify the repelling and attracting effects of a specific structure on free electrons, as shown in FIG. 15. It is observed that upon incorporation of TFAn, the partial discharge magnitude increases significantly, which is attributed to absence of a specific structure in certain molecular chain segments to constrain free electron motion. These results further verify that highly rigid curing agents can effectively suppress free electron motion, which plays a positive role in enhancing the dielectric strengths of the systems.

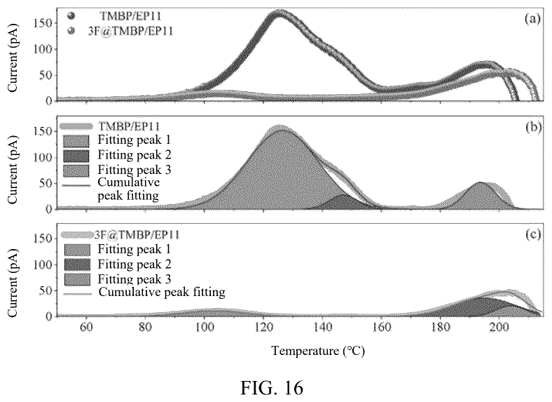

The trap distribution curves of the epoxy films were obtained through TSC analysis, as shown in FIG. 16(a). The trap energy levels and trapped charge quantities of two crosslinking systems were determined using a full width at half maximum method, as shown in Table 3.

TABLE 3
Trap energy levels and trapped charge quantities of different epoxy films

| | Curing system | | | | | | | | | | | |
|---|---|---|---|---|---|---|---|---|---|---|---|---|
| | TMBP/EP11 | | | | | | 3F@TMBP/EP11 | | | | | |
| Fitting peak | 1 | | 2 | | 3 | | 1 | | 2 | | 3 | |
| Trap energy level | 1.2 | eV | 3.3 | eV | 3.9 | eV | 1.2 | eV | 1.9 | eV | 4 | eV |
| Trapped charge | 91.8 | nC | 6.7 | nC | 13.16 | nC | 6.12 | nC | 19 | nC | 5.3 | nC |

quantity

Following incorporation of C—F bonds, the trap energy levels and trapped charge quantities of the crosslinking systems are significantly reduced. This effect is attributed to a decrease in the crosslinking density of the crosslinked structure, which results in fewer deep traps in the polymer. At this point, the restricting effect of the crosslinked structure on free electrons diminishes, and free electrons gain greater kinetic energy to impact the crosslinked structure, such that the dielectric strengths of the epoxy films are reduced.

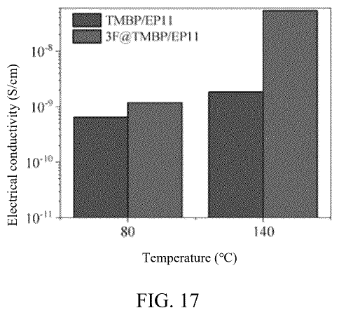

To further verify the effects of C—F bond incorporation and temperature on the voltage endurance of the material, electrical conductivity was tested on C—F bond-modified and liquid crystalline molecule-modified epoxy films at different temperatures, with the test results shown in FIG. 17. The electrical conductivity test results of the TMBP/EP11 system and the 3F@TMBP/EP11 system at different temperatures demonstrate consistency with both breakdown performance and TSC test results. Specifically, incorporation of C—F bonds induces a relative reduction in the rigidity of molecular chain segments and a decrease in the crosslinking density of the crosslinked structure, which induces fewer deep traps in the polymer. At this point, the restraining effect of the crosslinked structure on free electrons is diminished, and thus the electrical conductivity increases. A comparison of the electrical conductivity test results of the identical system at different temperatures reveals that an increase in temperature elevates a carrier density, such that the electrical conductivity exhibits an increasing trend.

(8) Study on Energy Storage Characteristics of Epoxy Films Modified with Highly Polarized C—F Bonds and Liquid Crystalline Molecules

### 1) Study on Polarization Performance of C—F Bond-Modified and Liquid Crystalline Molecule-Modified Epoxy Films

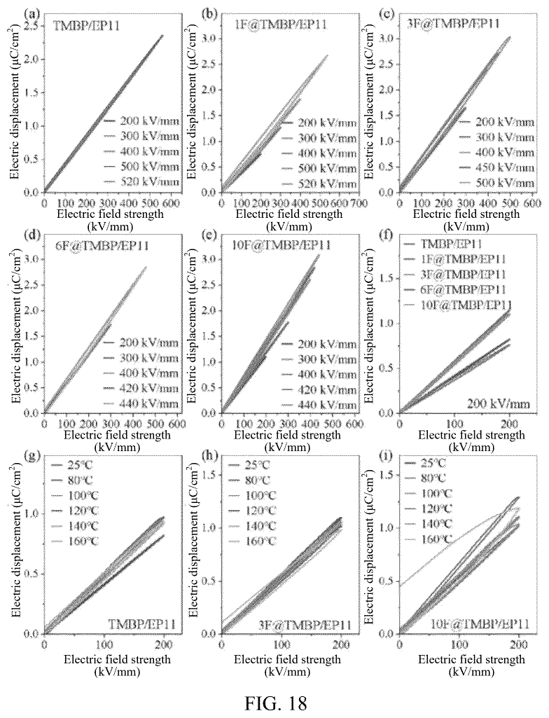

FIG. 18 illustrates electric hysteresis loops of epoxy films at different electric field strengths and test temperatures. A polarization intensity of the thin film increases with enhanced electric field strength. Based on the dielectric spectroscopy test results, all films exhibit extremely low magnetic hysteresis losses and extremely narrow electric hysteresis loops at room temperature due to the very low dielectric losses of the epoxy films, which provides a critical guarantee for improving the charge-discharge efficiency.

Collectively, under identical electric field conditions, the TMBP/EP11 system exhibits the lowest electric displacement. Following incorporation of C—F bonds, the electric displacement progressively increases, which is attributable to the elevated dielectric constant of the epoxy film resulting from C—F bond incorporation, where the highly polar C—F bonds effectively enhance polarization of the crosslinking systems. To study temperature effects on polarization performance of the crosslinking systems, electric hysteresis loop tests were performed at an electric field strength of 200 kV/mm and different temperatures. When the ambient temperature remains below 120° C., three tested films maintain performance characteristics equivalent to those observed at room temperature. When the temperature rises to 140° C., both the TMBP/EP11 system and the 3F@TMBP/EP11 system still maintain a narrow spacing between the charge-discharge curves of electric hysteresis loops, which is attributable to the elevated glass transition temperatures. When the ambient temperature is within the glass transition temperature, the dielectric loss remains stable. The epoxy film of the 10F@TMBP/EP11 system exhibits a glass transition temperature of merely 135° C. At this point, the ambient temperature exceeds the glass transition temperature, and thus the dielectric loss increases, thereby resulting in an enlarged spacing between the charge-discharge curves of the electric hysteresis loops. After the ambient temperature is further raised to 160° C., the 10F@TMBP/EP11 system exhibits a progressive enlargement of the spacing between charge-discharge curves of the electric hysteresis loops. Different from the 10F@TMBP/EP11 system, the TMBP/EP11 system still maintains low dielectric loss and narrow electric hysteresis loops even at 160° C. under the impact of high glass transition temperature.

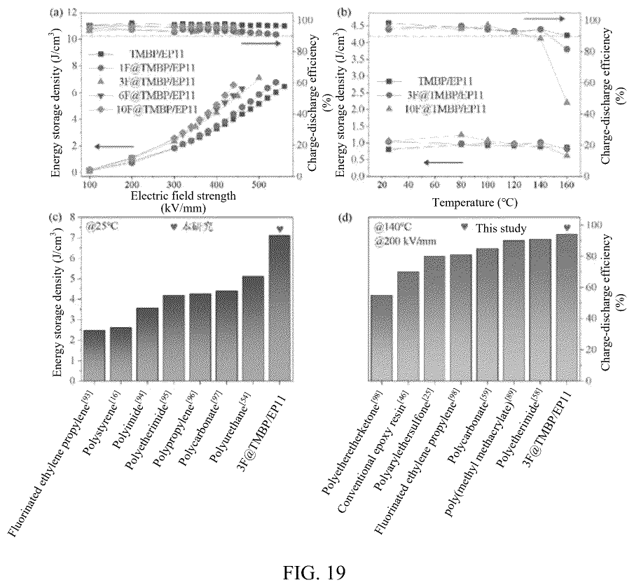

2) Based on the electric hysteresis loop test results, the energy storage density and charge-discharge efficiency of each crosslinking system at different electric field strengths and different temperatures are determined by calculating area integration. FIG. 19(a) illustrates a comparison of energy storage performances of epoxy films modified with highly polarized C—F bonds and liquid crystalline molecules at room temperature. With increasing incorporation of C—F bonds, the epoxy films demonstrate a rising trend in energy storage density under identical electric field conditions. For example, at room temperature and 400 kV/mm, the energy storage densities of five epoxy films are 3.28 J/cm³ (TMBP/EP11), 3.49 J/cm³ (1F@TMBP/EP11), 4.49 J/cm³ (3F@TMBP/EP11), 4.75 J/cm³ (6F@TMBP/EP11), and 5.07 J/cm³ (10F@TMBP/EP11). Due to the highest dielectric constant, the 10F@TMBP/EP11 system exhibits the maximum energy storage density under identical electric field conditions. All five systems still maintain high charge-discharge efficiencies exceeding 90% at room temperature prior to electric breakdown, with the lowest being the 1F@TMBP/EP11 system which remains a charge-discharge efficiency of 90.9% at room temperature and 540 kV/mm. Such low energy loss is advantageous for application of this study in high-frequency charge-discharge devices.

FIG. 19(b) illustrates a comparison of energy storage performances of epoxy films modified with highly polarized C—F bonds and liquid crystalline molecules at different temperatures. Consistent with high-temperature dielectric spectroscopy test results, the 10F@TMBP/EP11 system exhibits a marked decline in charge-discharge efficiency when tested above 140° C. due to abrupt dielectric loss increase. At 140° C. and 200 kV/mm, the 10F@TMBP/EP11 system retains an energy storage density of 0.95 J/cm³ and an energy storage efficiency of 88.3%. When the temperature rises to 160° C., the energy storage density drops to 0.62 J/cm³, and the energy storage efficiency declines to 47.2%. The 3F@TMBP/EP11 system demonstrates stable and superior energy storage performance under both room-temperature and high-temperature conditions. At room temperature and 500 kV/mm, the energy storage density and the charge-discharge efficiency reach 7.1 J/cm³ and 91.5%, respectively; at 140° C. and 200 kV/mm, the energy storage density and the charge-discharge efficiency are 1.01 J/cm³ and 94.3%, respectively; and at 160° C. and 200 kV/mm, the energy storage density and the charge-discharge efficiency achieve 0.83 J/cm³ and 81.5%, respectively.

FIG. 19(c) illustrates a comparison in energy storage density between the 3F@TMBP/EP11 film and other studies or commercial films at room temperature with a charge-discharge efficiency exceeding 90%, and the 3F@TMBP/EP11 film exhibits an energy storage density of 7.1 J/cm³ and a charge-discharge efficiency of 91.5% at room temperature and 500 kV/mm. Although linear dielectric materials such as polypropylene (PP), polyimide (PI), and polyetherimide (PEI) exhibit an exceptionally high charge-discharge efficiency, the excessively low dielectric constant (<3.5) restricts improvement in energy storage density. Epoxy resin, a representative thermosetting polymer, exhibits linear polarization characteristics, and the dense crosslinking network imparts an exceptionally high charge-discharge efficiency. The polar C—N bonds in cured epoxy resins contribute to an elevated dielectric constant (>4). Further incorporation of highly polar C—F bonds further increases the dielectric constant to 5.1 at 10 Hz. These factors ensure that the epoxy films achieve a high energy storage density while maintaining a charge-discharge efficiency exceeding 90%. FIG. 19(d) illustrates a comparison in energy storage density between the 3F@TMBP/EP11 film in this study and other studies or commercial films at 140° C. and 200 kV/mm. The 3F@TMBP/EP11 film exhibits an energy storage density of 1.02 J/cm³ and a charge-discharge efficiency of 94.3% under the identical conditions. For example, polycarbonate and PEI are typical high-temperature-resistant dielectric materials, and high-rigidity groups in the molecular structures provide guarantee for a high charge-discharge efficiency at high temperatures. Compared with common high-temperature-resistant dielectric materials, conventional epoxy resins exhibit a substantially inferior thermal resistance. In the present disclosure, the thermal resistance is enhanced by incorporating liquid crystalline molecules through a curing reaction between epoxy groups and amino groups to construct a highly rigid crosslinked structure.

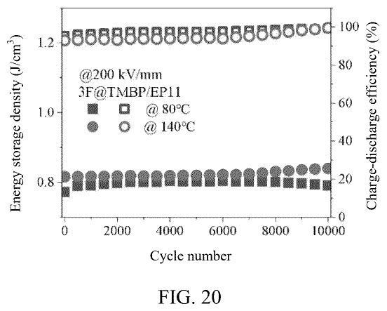

Based on the above results, the cycling performance of the 3F@TMBP/EP11 film was tested at high temperatures to assess a long-term operational stability of the film under high-temperature conditions. As shown in FIG. 20, high-temperature energy storage cycling performance tests were performed on the 3F@TMBP/EP11 film at 200 kV/mm and different temperatures. After 10,000 cycles at 80° C. and 140° C., the energy storage density and the charge-discharge efficiency exhibit negligible variation, indicating the exceptional reliability of the epoxy film under the operational conditions of 140° C. and 200 kV/mm. Commercial BOPP films undergo breakdown in 10,000 cycles at 120° C. and 200 kV/mm, and exhibit a 16% reduction in energy storage density. Compared with BOPP films, the 3F@TMBP/EP11 film demonstrates markedly superior long-term stability during service at high temperatures.

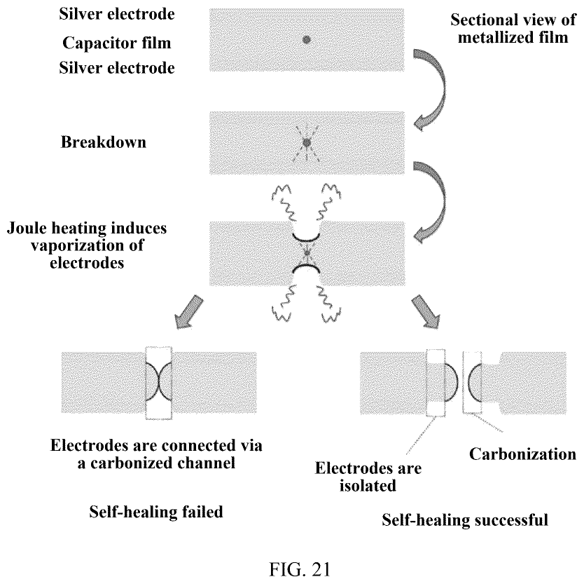

2) Full consideration must be given to long-term operational reliability and stability for film capacitors during engineering applications. In practical film capacitor applications, large-area dielectric polymer films are metallized with metal layers deposited as electrodes on both surfaces. In this structure, the metallized layer functions as a fuse when localized breakdown occurs to the film during operation. FIG. 21 illustrates a self-healing process of the metallized film. Localized electric field may be intensified due to defects inherent in polymer materials, and breakdown is initiated at weak spots. During the breakdown process, the ultra-high-temperature (>8,000 K) arcing rapidly destroys electrode materials, and simultaneously causes polymer decomposition, which releases various chemical residues including gases such as CO, H₂, CH₄, C₂H₂ and a graphitic solid phase. It is noteworthy that the electric breakdown process may also induce vaporization of the metallic electrodes on the film surface. Particularly, when newly exposed surface areas underlying the metallic electrodes are sufficiently large to isolate the carbonized perforation and the arcing is extinguished in a timely manner, the film achieves “self-healing” in terms of insulation functionality, and subsequently, the film may resume normal operation in capacitor applications. Conversely, the film permanently loses functionality following a single occurrence of breakdown. During the self-healing process, dielectric defects are autonomously eliminated within <10 μs without external intervention, thereby enhancing capacitor reliability.

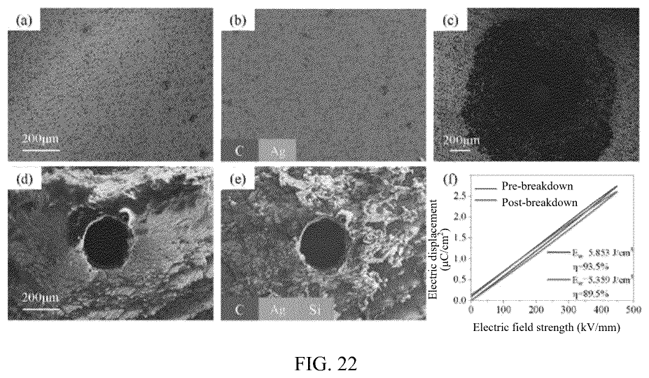

Currently, no theoretical relationship is verified clearly between the chemical composition of a polymer dielectric and the self-healing capability thereof. However, some research experiences indicate that the chemical composition of a polymer dielectric exhibits a correlation with the self-healing capability thereof. For a polymer dielectric represented by the general formula C_{α}H_{β}O_{γ}N_{δ}S_{θ}, the self-healing capability deteriorates as a ratio of (α+δ+θ) to (β+λ) increases. When the above ratio is relatively small, less graphite is deposited during the self-healing process, thereby preventing formation of a conductive graphitic bridge, which ultimately ensures favorable self-healing performance. The ratios of PP and PET are 0.5 and 0.75, respectively, and both demonstrate favorable self-healing behaviors. The 3F@TMBP/EP11 film in the present disclosure exhibits a ratio of approximately 0.68, which is far lower than PEI (1.3), PI (1.6), and PEEK (1.33), with a self-healing capability intermediate between PP and PET. FIG. 22 illustrates a comparison of morphologies and energy storage performances of the epoxy film before and after the initial breakdown event.

As shown in FIG. 22(a) to (e), the pre-breakdown morphology and elemental distribution of the film were observed via an SEM and EDS. Upon breakdown of the specimen, a perforation with a diameter of 220 μm was observed via a polarized light microscopy and an SEM, which was attributable to potential defects at the perforation site. When an external electric field was applied to both sides of the electrode, localized electric field distortion was induced at the defect site, and subsequently the breakdown was triggered. Polarized light microscopy images distinctly reveal the disappearance of the silver electrode surrounding the breakdown perforation. The arcing generated during breakdown typically induces intense Joule heating that not only damages the material but also causes vaporization of surrounding silver electrodes. Analytical results obtained through post-breakdown characterization via the EDS further confirm the above viewpoint. As shown in FIG. 22(f), after breakdown of the 3F@TMBP/EP11 film at 500 kV/mm during the first charge-discharge cycle, the 3F@TMBP/EP11 film was tested again. The results demonstrate that the 3F@TMBP/EP11 film still functions properly to complete charge-discharge processes under an electric field of 450 kV/mm. Prior to breakdown occurrence, the 3F@TMBP/EP11 film exhibits an energy storage density of 5.583 J/cm³ and a charge-discharge efficiency of 93.5% at room temperature and 450 kV/mm. Following the occurrence of breakdown, the energy storage performances were measured again. The results indicate that the 3F@TMBP/EP11 film exhibits an energy storage density of 5.359 J/cm³ and a charge-discharge efficiency of 89.5% under identical conditions. Although a slight reduction is present in both the energy storage density and the charge-discharge efficiency, it is still indicated that the 3F@TMBP/EP11 film undergoes successful self-healing.

In summary, incorporation of highly polarized C—F bonds into the liquid crystalline molecule-modified epoxy film effectively enhances polarization performance, increases the energy storage density of the epoxy film, and maintains a relatively high glass transition temperature to enhance the high-temperature energy storage characteristics of the epoxy film.

Therefore, the above technology for preparing a high-temperature-resistant epoxy energy storage film based on a liquid crystalline ordered structure is adopted; incorporation of highly polarized C—F bonds into the liquid crystalline molecule-modified epoxy film effectively enhances polarization performance, increases the energy storage density of the epoxy film, and maintains a relatively high glass transition temperature to enhance the high-temperature energy storage characteristics of the epoxy film, which solves the problem of sharp degradation in energy storage performance of commercial dielectric films, and provides a new idea of developing high-performance epoxy materials for the field of dielectric energy storage.

Finally, it should be stated that the above embodiments are only used for explaining, rather than limiting, the technical solutions of the present disclosure. Although the present disclosure is described in detail with reference to the preferred embodiments, those of ordinary skill in the art should understand that modifications or equivalent substitutions may be made to the technical solutions of the present disclosure, and such modifications or equivalent substitutions will not make the modified technical solutions deviate from the spirit and scope of the technical solutions of the present disclosure.

What is claimed is:

1. A method for preparing a high-temperature-resistant epoxy energy storage film based on a liquid crystalline ordered structure, comprising the following steps:
S1, mixing a biphenyl type liquid crystalline epoxy (LCE) monomer, a bisphenol-A epoxy monomer, and a curing agent, while performing magnetic stirring treatment and oil-bath heating melting treatment, to obtain a molten mixture; and
S2, performing degassing treatment on the molten mixture obtained in S1, and then pouring the degassed mixture into a mold; and performing heating curing treatment on the degassed mixture through a hot-press approach to obtain an epoxy film; wherein
in S1, the curing agent comprises 2,3,4-trifluoroaniline and 4,4′-diaminodiphenylmethane; and
in S2, the heating curing treatment through a hot-press approach is specifically as follows:
first, the mold is preheated, a PET release film is then placed on a bottom of the mold, and the degassed molten mixture is poured into the copper foil mold having a thickness of 10 μm; next, an additional PET release film is overlaid on a top of the mold, the mold is sandwiched between mirror-finished stainless steel plates, and the assembly is put into a hot press for stepwise-temperature-increasing heating curing treatment; and
a temperature of the preheating treatment is 100-110° C., a temperature of the heating curing treatment is 105-200° C., and a curing duration is 10 h.

2. The method for preparing a high-temperature-resistant epoxy energy storage film based on a liquid crystalline ordered structure according to claim 1, wherein, in S1, the biphenyl type LCE monomer is a tetramethylbiphenyl epoxy monomer.

3. The method for preparing a high-temperature-resistant epoxy energy storage film based on a liquid crystalline ordered structure according to claim 1, wherein, in S1, a molar ratio of a sum of the bisphenol-A epoxy monomer and the biphenyl type LCE monomer to the curing agent is 3:2.

4. The method for preparing a high-temperature-resistant epoxy energy storage film based on a liquid crystalline ordered structure according to claim 1, wherein, in S1, the magnetic stirring treatment and oil-bath heating melting treatment are specifically as follows:
a magnetic stir bar is added, and the mixture is then placed in an oil bath, and heated to a molten state, while stirred by a magnetic stirrer.

5. The method for preparing a high-temperature-resistant epoxy energy storage film based on a liquid crystalline ordered structure according to claim 1, wherein a temperature of the oil-bath heating is 105° C., a speed of the stirring is 150-250 r/min, and a duration of the stirring is 10 min.

6. The method for preparing a high-temperature-resistant epoxy energy storage film based on a liquid crystalline ordered structure according to claim 1, wherein, in S2, the degassing treatment is specifically as follows:
the molten mixture is placed in a vacuum drying oven and degassed in a heating reflux manner until no bubbles appear.

7. The method for preparing a high-temperature-resistant epoxy energy storage film based on a liquid crystalline ordered structure according to claim 6, wherein a temperature of the degassing treatment is 105-110° C., and a duration of the degassing treatment is 3-5 min.
